(19) United States
(12) Patent Application Publication
(10) Pub. No.: US 2007/0173585 A1
(43) Pub. Date: Jul. 26, 2007

(54) Polyester nanocomposite filaments and fiber

(76) Inventors: Gregory James Sevenich, Mount Juliet, TN (US); David T. Williamson, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/642,182

(22) Filed: Dec. 20, 2006

Related U.S. Application Data
(63) Continuation-in-part of application No. 11/312,068, filed on Dec. 20, 2005.
(60) Provisional application No. 60/638,225, filed on Dec. 22, 2004.

(51) Int. Cl. C08K 9/04

(52) U.S. Cl. 524/445

(57) ABSTRACT

Mechanical properties of monofilament polyester fibers and multifilament polyester yarns prepared therefrom are improved by incorporating into the polymer from which the monofilament fibers are formed an effective amount of exfoliated sepiolite-type clay.

### CROSS REFERENCE TO RELATED APPLICATIONS

This application is a continuation-in-part of U.S. patent application Ser. No. 11/312068, filed Dec. 20, 2005, which in turn claims the benefit of priority of U.S. Provisional Application No. 60/638,225, filed Dec. 22, 2004.

### FIELD OF THE INVENTION

Mechanical properties of polyester monofilaments and multifilament yarns prepared therefrom are improved by incorporating into the polymer from which the monofilaments are formed an effective amount of exfoliated sepiolite-type clay.

### TECHNICAL BACKGROUND OF THE INVENTION

Polymeric monofilaments are used as reinforcements for rubber articles, fishing lines, toothbrush bristles, paintbrush bristles and the like. In addition, woven fabrics produced from monofilaments are used, for example, in industrial belts and paper machine clothing.

Polyester monofilaments offer high strength and good dimensional stability. For example, U.S. Pat. Nos. 3,051,212 and 3,869,427 disclose the use of polyester monofilaments as reinforcements for rubber articles. The use of polyester monofilaments to make fabric for processing and drying wet pulp to make paper is described in U.S. Pat. Nos. 3,858,623, 4,071,050, 4,374,960, 5,169,499, 5,169,711, 5,283,110, 5,297,590, 5,635,298, 5,692,938, 5,885,709, and Kirk-Othmer Encyclopedia of Chemical Technology (2nd Ed.) (Interscience) 1967, Vol. 14, pp. 503-508 and the references cited therein. For example, linear poly(ethylene terephthalate)s having inherent viscosities between 0.60 and 1.0 dL/g are known for use in the production of monofilaments. Generally, it has been disclosed that the inherent viscosity is greater than 0.70 dL/g. U.S. Pat. Nos. 3,051,212, 3,627,867, 3,657,191, 3,869,427, 3,959,215, 3,959,228, 3,975,329, 4,016,142, 4,017,463, 4,139,521, 4,374,960, 5,472,780, 5,635,298, 5,763,538, and 5,885,709 disclose the use of high molecular weight, linear polyesters for use in the manufacture of monofilaments. The inherent viscosity of a polymer is an indicator of its molecular weight.

Poly(ethylene terephthalate) (“PET”) filaments are employed in industrial applications such as tire cords, composites, belts, and textiles. For these applications an increase in filament modulus without sacrificing tenacity accompanied by a minimal increase in manufacturing costs would be readily accepted by industry.

One suggested approach to meet this need is to use instead a specialty polymer with an inherently higher modulus, such as poly(ethylene naphthalate). However, such polymers are much more expensive than PET.

Another approach is to produce a nanocomposite of PET and a clay. Nanocomposites are polymers reinforced with nanometer sized particles, i.e., particles with a dimension on the order of 1 to several hundred nanometers. However, Kim et al. reported that modulus and tenacity was reduced in experimentally prepared nanosilica-filled PET fibers (Y. K. Kim et al., Materials Research Society Symposium Proceedings (2003), Vol. 740, 441-446).

For the reasons set forth above, there exists a need for an improved process for dispersing and exfoliating nanoparticle filler material in a polyester matrix in order to increase the modulus of polyester monofilament and multifilament yarn.

### SUMMARY OF THE INVENTION

A method is provided herein for increasing modulus of polyester monofilament, comprising the steps:
a. preparing a polyester nanocomposite by mixing a sepiolite-type clay with at least one polyester precursor selected from the group consisting of
   (i) at least one diacid or diester and at least one diol;
   (ii) at least one polymerizable polyester monomer;
   (iii) at least one linear polyester oligomer, and
   (iv) at least one macrocyclic polyester oligomer;
b. subsequently polymerizing the at least one polyester precursor in the presence or absence of solvent; and
c. spinning monofilament comprising the polyester nanocomposite so produced; and
d. optionally, preparing multifilament yarn comprising the monofilament so produced.

Also provided are monofilament and multifilament yarn comprising a polyester nanocomposite into which is incorporated an effective amount of exfoliated sepiolite-type clay.

### BRIEF DESCRIPTION OF THE DRAWINGS

FIG. 1 is an illustration showing particle dimensions.

### DETAILED DESCRIPTION OF THE INVENTION

In the context of this disclosure, a number of terms shall be utilized.

As used herein, the term “fiber” means any material with slender, elongated structure such as polymer or natural fibers. A fiber is generally characterized by having a length at least 100 times its diameter or width.

As used herein, the term “yarn” is a generic term for a continuous strand of textile fibers, filaments, or material in a form suitable for knitting, weaving, or otherwise intertwining to form a textile fabric As used herein, the term “filament” means a fiber of an indefinite or extreme length such as found naturally in silk.

As used herein, the term “monofilament” means any single filament of a manufactured fiber, usually of a denier higher than 14. Instead of a group of filaments being extruded through a spinneret to form a yarn, monofilaments generally are spun individually.

As used herein, the term “multifilament” refers to yarn consisting of many continuous filaments or strands, as opposed to monofilament which is one strand. Most textile filament yarns are multifilament.

As used herein, the term “denier” is a weight-per-unit-length measure of any linear material. Officially, it is the number of unit weights of 0.05 grams per 450-meter length. Denier is a direct numbering system in which the lower numbers represent the finer sizes and the higher numbers the coarser sizes.

As used herein, the term “draw ratio” means the ratio of the length of a drawn monofilament to its undrawn length.

As used herein, the term “nanocomposite” or “polymer nanocomposite” or “nanocomposite composition” means a polymeric material which contains particles, dispersed throughout the polymeric material, having at least one dimension in the 0.1 to 100 nm range (“nanoparticles”). The polymeric material in which the nanoparticles are dispersed is often referred to as the “polymer matrix.” The term “polyester nanocomposite” refers to a nanocomposite in which the polymeric material includes at least one polyester.

As used herein, the term “sepiolite-type clay” refers to both sepiolite and attapulgite (palygorskite) clays.

The term “exfoliate” literally refers to casting off in scales, laminae, or splinters, or to spread or extend by or as if by opening out leaves. In the case of smectic clays, “exfoliation” refers to the separation of platelets from the smectic clay and dispersion of these platelets throughout the polymer matrix. As used herein, for sepiolite-type clays, which are fibrous in nature, “exfoliation” or “exfoliated” means the separation of fiber bundles or aggregates into nanometer diameter fibers which are then dispersed throughout the polymer matrix.

As used herein, “an effective amount” means that enough stiffness or modulus enhancing additive is present to cause a detectable increase in the stiffness of the fiber of interest. This is from about 0.1% by wt. to about 10% by wt. of the weight of the fiber.

As used herein, “an alkylene group” means —CₙH₂ₙ— where n≧1.

As used herein, “a cycloalkylene group” means a cyclic alkylene group, —CₙH₂ₙ₋ₓ—, where x represents the number of H's replaced by cyclization(s).

As used herein, “a mono- or polyoxyalkylene group” means

[—(CH₂)_{y}—O—]ₙ—(CH₂)_{y}—, wherein y is an integer greater than 1 and n is an integer greater than 0.

As used herein, “an alicyclic group” means a non-aromatic hydrocarbon group containing a cyclic structure therein.

As used herein, “a divalent aromatic group” means an aromatic group with links to other parts of the macrocyclic molecule. For example, a divalent aromatic group may include a meta- or para-linked monocyclic aromatic group.

As used herein, “polyester” means a condensation polymer in which more than 50 percent of the groups connecting repeat units are ester groups. Thus polyesters may include polyesters, poly(ester-amides) and poly(ester-imides), so long as more than half of the connecting groups are ester groups. Preferably at least 70% of the connecting groups are esters, more preferably at least 90% of the connecting groups are ester, and especially preferably essentially all of the connecting groups are esters. The proportion of ester connecting groups can be estimated to a first approximation by the molar ratios of monomers used to make the polyester.

As used herein, “PET” means a polyester in which at least 80, more preferably at least 90, mole percent of the diol repeat units are from ethylene glycol and at least 80, more preferably at least 90, mole percent of the dicarboxylic acid repeat units are from terephthalic acid.

As used herein, “polyester precursor” means material which can be polymerized to a polyester, such as diacid (or diester)/diol mixtures, polymerizable polyester monomers, and polyester oligomers.

As used herein, “polymerizable polyester monomer” means a monomeric compound which polymerizes to a polymer either by itself or with other monomers (which are also present). Some examples of such compounds are hydroxyacids, such as the hydroxybenzoic acids and hydroxynaphthoic acids, and bis(2-hydroxyethyl) terephthalate.

As used herein, “oligomer” means a molecule that contains 2 or more identifiable structural repeat units of the same or different formula.

As used herein, “linear polyester oligomer” means oligomeric material, excluding macrocyclic polyester oligomers (vide infra), which by itself or in the presence of monomers can polymerize to a higher molecular weight polyester. Linear polyester oligomers include, for example, oligomers of linear polyesters and oligomers of polymerizable polyester monomers. For example, reaction of dimethyl terephthalate or terephthalic acid with ethylene glycol, when carried out to remove methyl ester or carboxylic groups, usually yields a mixture of bis(2-hydroxyethyl) terephthalate and a variety of oligomers: oligomers of bis(2-hydroxyethyl) terephthalate, oligomers of mono(2-hydroxyethyl) terephthalate (which contain carboxyl groups), and polyester oligomers capable of being further extended. Preferably, in the practice of the present invention, such oligomers will have an average degree of polymerization (average number of monomer units) of about 20 or less, more preferably about 10 or less.

As used herein, a “macrocyclic” molecule means a cyclic molecule having at least one ring within its molecular structure that contains 8 or more atoms covalently connected to form the ring.

As used herein, “macrocyclic polyester oligomer” means a macrocyclic oligomer containing 2 or more identifiable ester functional repeat units of the same or different formula. A macrocyclic polyester oligomer typically refers to multiple molecules of one specific formula having varying ring sizes. However, a macrocyclic polyester oligomer may also include multiple molecules of different formulae having varying numbers of the same or different structural repeat units. A macrocyclic polyester oligomer may be a co-oligoester or multi-oligoester, i.e., a polyester oligomer having two or more different structural repeat units having an ester functionality within one cyclic molecule.

Where a range of numerical values is recited herein, unless otherwise stated, the range is intended to include the endpoints thereof, and all integers and fractions within the range. It is not intended that the scope of the invention be limited to the specific values recited when defining a range.

A method is provided herein for increasing modulus of polyester monofilament, comprising the steps:
a. preparing a polyester nanocomposite by mixing a sepiolite-type clay with at least one polyester precursor selected from the group consisting of
   (i) at least one diacid or diester and at least one diol;
   (ii) at least one polymerizable polyester monomer;
   (iii) at least one linear polyester oligomer, and
   (iv) at least one macrocyclic polyester oligomer;
b. subsequently polymerizing the at least one polyester precursor in the presence or absence of solvent; and
c. spinning monofilament comprising the polyester nanocomposite so produced; and
d. optionally, preparing multifilament yarn comprising the monofilament so produced.
   Preparing the Polyester Nanocomposite

The nanocomposite contains an effective amount of exfoliated sepiolite, exfoliated attapulgite, or a mixture of exfoliated sepiolite and exfoliated attapulgite. As used herein, “an effective amount” means that enough exfoliated sepiolite-type clay is present to cause a detectable change in stiffness (measured as modulus). This is from about 0.1% by wt. to about 10% by wt. of the monofilament.

### Sepiolite and Attapulgite

Clay minerals and their industrial applications are reviewed by H. H. Murray in Applied Clay Science 17(2000) 207-221. Two types of clay minerals are commonly used in nanocomposites: kaolin and smectite. The molecules of kaolin are arranged in two sheets or plates, one of silica and one of alumina. The most widely used smectites are sodium montmorillonite and calcium montmorillonite. Smectites are arranged in two silica sheets and one alumina sheet. The molecules of the montmorillonite clay minerals are less firmly linked together than those of the kaolin group and are thus further apart.

Sepiolite (Mg₄Si₆O₁₅(OH)₂.6(H₂O) is a hydrated magnesium silicate filler that exhibits a high aspect ratio due to its fibrous structure. Unique among the silicates, sepiolite is composed of long lath-like crystallites in which the silica chains run parallel to the axis of the fiber. The material has been shown to consist of two forms, an α and a β form. The αform is known to be long bundles of fibers and the β form is present as amorphous aggregates.

Attapulgite (also known as palygorskite) is almost structurally and chemically identical to sepiolite except that attapulgite has a slightly smaller unit cell. As used herein, the term “sepiolite-type clay” includes attapulgite as well as sepiolite itself.

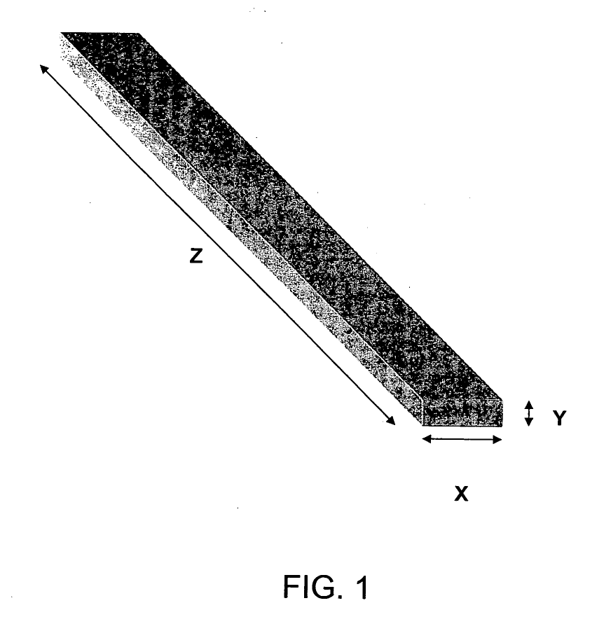

Sepiolite-type clays are layered fibrous materials in which each layer is made up of two sheets of tetrahedral silica units bonded to a central sheet of octahedral units containing magnesium ions (see, e.g., FIGS. 1 and 2 in L. Bokobza et al., Polymer International, 53, 1060-1065 (2004)). The fibers stick together to form fiber bundles, which in turn can form agglomerates. These agglomerates can be broken apart by industrial processes such as micronization or chemical modification (see, e.g., European Patent 170,299 to Tolsa, S. A.).

The sepiolite-type clays used in the compositions described herein are unmodified. The term “unmodified” means that the surface of the sepiolite-type clay has not been treated with an organic compound such as an onium compound (for example, to make its surface less polar).

The width (x) and thickness (y) of the sepiolite-type clay particle contained in the compositions described herein are each less than 50 nm (FIG. 1). The length (z) of a sepiolite-type particle is also illustrated in FIG. 1.

In one embodiment, the sepiolite-type clay is rheological grade, such as described in European patent applications EP-A-0454222 and EP-A-0170299 and marketed under the trademark Pangel® by Tolsa, S. A., Madrid, Spain. As described therein, “rheological grade” denotes a sepiolite-type clay with a specific surface area greater than 120 m²/g (N₂, BET), and typical fiber dimensions: 200 to 2000 nm long, 10-30 nm wide, and 5-10 nm thick.

Rheological grade sepiolite is obtained from natural sepiolite by means of special micronization processes that substantially prevent breakage of the sepiolite fibers, such that the sepiolite disperses easily in water and other polar liquids, and has an external surface with a high degree of irregularity, a high specific surface, greater than 300 m²/g and a high density of active centers for adsorption, that provide it a very high water retaining capacity upon being capable of forming, with relative ease, hydrogen bridges with the active centers. The microfibrous nature of the rheological grade sepiolite particles makes sepiolite a material with high porosity and low apparent density.

Additionally, rheological grade sepiolite has a very low cationic exchange capacity (10-20 meq/100 g) and the interaction with electrolytes is very weak, which in turn causes rheological grade sepiolite not to be practically affected by the presence of salts in the medium in which it is found, and therefore, it remains stable in a broad pH range.

The above-mentioned qualities of rheological grade sepiolite can also be attributed to rheological grade attapulgite with particle sizes smaller than 40 microns, such as for example the range of ATTAGEL® goods (for example ATTAGEL 40 and ATTAGEL 50) manufactured and marketed by the firm Engelhard Corporation, United States, and the MIN-U-GEL range of Floridin Company.

The amount of sepiolite-type clay used in the present invention ranges from about 0.1 to about 10 wt % based on the final composite composition. The specific amount chosen will depend on the intended use of the nanocomposite, as is well understood in the art. “Masterbatches” of the nanocomposite composition containing relatively high concentrations of exfoliated clay may also be made and used. For example, a nanocomposite composition masterbatch containing 30% by weight of the exfoliated clay may be used. If a composition having 3 weight percent of the exfoliated clay is needed, the composition containing the 3 weight percent may be made by melt mixing 1 part by weight of the 30% masterbatch with 9 parts by weight of the “pure” polyester. During this melt mixing, other desired components can also be added to form the final desired composition.

### Polyesters

The polyester is selected from the group consisting of: at least one polyester homopolymer; at least one polyester copolymer; a polymeric blend comprising at least one polyester homopolymer or copolymer; and mixtures of these.

The polyester may be any polyester, or mixture of polyesters, with the requisite melting point. Preferably the melting point of the polyester is about 150° C. or higher, and more preferably about 200° C. or higher. Polyesters (which have mostly or all ester linking groups) are normally derived from one or more dicarboxylic acids and one or more diols. They can also be produced from polymerizable polyester monomers or from macrocyclic polyester oligomers.

Polyesters most suitable for use in practicing the invention comprise isotropic thermoplastic polyester homopolymers and copolymers (both block and random). Examples are poly(ethylene terephthalate), poly(1,3-propylene terephthalate), poly(1,4-butylene terephthalate), a thermoplastic elastomeric polyester having poly(1,4-butylene terephthalate) and poly(tetramethylene ether)glycol blocks, poly(1,4-cylohexyldimethylene terephthalate), and polylactic acid.

The dicarboxylic acid component is selected from unsubstituted and substituted aromatic, aliphatic, unsaturated, and alicyclic dicarboxylic acids and the lower alkyl esters of dicarboxylic acids preferably having from 2 carbons to 36 carbons. Specific examples of suitable dicarboxylic acid components include terephthalic acid, dimethyl terephthalate, isophthalic acid, dimethyl isophthalate, 2,6-napthalene dicarboxylic acid, dimethyl-2,6-naphthalate, 2,7-naphthalenedicarboxylic acid, dimethyl-2,7-naphthalate, 3,4′-diphenyl ether dicarboxylic acid, dimethyl-3,4′diphenyl ether dicarboxylate, 4,4′-diphenyl ether dicarboxylic acid, dimethyl-4,4′-diphenyl ether dicarboxylate, 3,4′-diphenyl sulfide dicarboxylic acid, dimethyl-3,4′-diphenyl sulfide dicarboxylate, 4,4′-diphenyl sulfide dicarboxylic acid, dimethyl4,4′-diphenyl sulfide dicarboxylate, 3,4′-diphenyl sulfone dicarboxylic acid, dimethyl-3,4′-diphenyl sulfone dicarboxylate, 4,4′-diphenyl sulfone dicarboxylic acid, dimethyl4,4′-diphenyl sulfone dicarboxylate, 3,4′-benzophenonedicarboxylic acid, dimethyl-3,4′-benzophenonedicarboxylate, 4,4′-benzophenonedicarboxylic acid, dimethyl4,4′-benzophenonedicarboxylate, 1,4-naphthalene dicarboxylic acid, dimethyl-1,4-naphthalate, 4,4′-methylene bis(benzoic acid), dimethyl4,4′-methylenebis(benzoate), oxalic acid, dimethyl oxalate, malonic acid, dimethyl malonate, succinic acid, dimethyl succinate, methylsuccinic acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,1 1-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, 1,4-cyclohexanedicarboxylic acid, dimethyl-1,4-cyclohexanedicarboxylate, 1,3-cyclohexanedicarboxylic acid, dimethyl-1,3-cyclohexanedicarboxylate, 1,1-cyclohexanediacetic acid, metal salts of 5-sulfo-dimethylisophalate, fumaric acid, maleic anhydride, maleic acid, hexahydrophthalic acid phthalic acid and the like and mixtures derived there from. Other dicarboxylic acids suitable for use in forming the monofilaments will be apparent to those skilled in the art. Preferred dicarboxylic acids include terephthalic acid, dimethyl terephthalate, isophthalic acid, and dimethyl isophthalate.

The diol component is selected from unsubstituted, substituted, straight chain, branched, cyclic aliphatic, aliphatic-aromatic or aromatic diols having from 2 carbon atoms to 36 carbon atoms and poly(alkylene ether) glycols with molecular weights between about 250 to 4,000. Specific examples of the desirable diol component include ethylene glycol, 1,3-propanediol, 1,4-butanediol, 1,6-hexanediol, 1,8-octanediol, 1,10-decanediol, 1,12-dodecanediol, 1,14-tetradecanediol, 1,16-hexadecanediol, dimer diol, 4,8-bis(hydroxymethyl)-tricyclo[5.2.1.0/2.6]decane, 1,4-cyclohexanedimethanol (both cis and trans structures), di(ethylene glycol), tri(ethylene glycol), poly(ethylene ether) glycols with molecular weights between 250 and 4000, poly(1,2-propylene ether) glycols with molecular weights between 250 and 4000, block poly(ethylene-co-propylene-co-ethylene ether) glycols with molecular weights between 250 and 4000, poly(1,3-propylene ether) glycols with molecular weights between 250 and 4000, poly(butylene ether) glycols with molecular weights between 250 and 4000 and the like and mixtures derived there from. Other diols suitable for use in forming the monofilaments will be apparent to those skilled in the art. These other Diols will contain the functional hydroxyl groups at any two separate places within the structure of the molecule in question. An obvious example is 1,2-propanediol.

The polyfunctional branching agent can be any material with three or more carboxylic acid functional groups, hydroxy functional groups or a mixture thereof. The term “carboxylic acid functional groups” is meant to include carboxylic acids, lower alkyl esters of carboxylic acids, glycolate esters of carboxylic acids, and the like and mixtures thereof. Specific examples of desirable polyfunctional branching agent components include 1,2,4-benzenetricarboxylic acid, (trimellitic acid), trimethyl-1,2,4-benzenetricarboxylate, tris(2-hyroxyethyl)-1,2,4-benzenetricarboxylate, trimethyl-1,2,4-benzenetricarboxylate, 1,2,4-benzenetricarboxylic anhydride, (trimellitic anhydride), 1,3,5-benzenetricarboxylic acid, 1,2,4,5-benzenetetracarboxylic acid, (pyromellitic acid), 1,2,4,5-benzenetetracarboxylic dianhydride, (pyromellitic anhydride), 3,3′,4,4′-benzophenonetetracarboxylic dianhydride, 1,4,5,8-naphthalenetetracarboxylic dianhydride, citric acid, tetrahydrofuran-2,3,4,5-tetracarboxylic acid, 1,3,5-cyclohexanetricarboxylic acid, pentaerythritol, 2-(hydroxymethyl)-1,3-propanediol, 2,2-bis(hydroxymethyl)propionic acid, trimer acid, and the like and mixtures there from. Essentially any polyfunctional material that includes three or more carboxylic acid or hydroxyl functions can be used, and such materials will be apparent to those skilled in the art.

The polyesters preferably have an inherent viscosity (IV) in the range of about 0.50 to 1.5 dL/g. More desirably, the inherent viscosity of the polyesters is in the range of about 0.60 to 1.3 dL/g, as measured on a 0.5 percent (weight/volume) solution of the polyester in a 50:50 (weight) solution of trifluoroacetic acid:dichloromethane solvent system according to ASTM 5225-98. The polymerization conditions can be adjusted by one skilled in the art to obtain the desired inherent viscosities.

The polyesters can be prepared by conventional polycondensation techniques. The product compositions can vary somewhat based on the method of preparation used, particularly with respect to the amount of diol that is present within the polymer. Although not preferred, the polyesters can be prepared using techniques that utilize acid chlorides. Such procedures are disclosed, for example, in R. Storbeck, et al., J. Appl. Polymer Science, Vol. 59, pp. 1199-1202 (1996), the disclosure of which is hereby incorporated herein by reference.

Preferably, the polyesters are produced by melt polymerization. In melt polymerization, the dicarboxylic acid component, (as acids, esters, or mixtures thereof), the diol component and the polyfunctional branching agent are combined in the presence of a catalyst to a high enough temperature that the monomers combine to form esters and diesters, then oligomers, and finally polymers. The polymeric product at the end of the polymerization process is a molten product. Generally, the diol component is volatile and distills from the reactor as the polymerization proceeds. Such procedures are disclosed, for example, in U.S. Pat. Nos. 3,563,942, 3,948,859, 4,094,721, 4,104,262, 4,166,895, 4,252,940, 4,390,687, 4,419,507, 4,585,687, 5,053,482, 5,292,783, 5,446,079, 5,480,962, and 6,063,464 and references cited therein.

The melt process conditions, particularly the amounts of monomers used, depend on the polymer composition desired. The amount of the diol component, dicarboxylic acid component, and branching agent are desirably chosen so that the final polymeric product contains the desired amounts of the various monomer units, desirably with equimolar amounts of monomer units derived from the respective diol and diacid components. Because of the volatility of some of the monomers, especially some of the diol components, and depending on such variables as whether the reactor is sealed, (i.e., is under pressure), the polymerization temperature ramp rate, and the efficiency of the distillation columns used in synthesizing the polymer, some of the monomers can be used in excess at the beginning of the polymerization reaction and removed by distillation as the reaction proceeds. This is particularly true of the diol component.

The exact amounts of monomers to be charged to a particular reactor can be determined by a skilled practitioner, but often will be in the ranges below. Excesses of the diacid and diol are often desirably charged, and the excess diacid and diol is desirably removed by distillation or other means of evaporation as the polymerization reaction proceeds. The diol component is desirably charged at a level 0 to 100 percent greater than the desired incorporation level in the final product. For example, for diol components that are volatile under the polymerization conditions, such as ethylene glycol, 1,3-propanediol, or 1,4-butanediol, 30 to 100 percent excesses are desirably charged. For less volatile diol components, such as the poly(alkylene ether) glycols or dimer diol, excesses may not be required.

The amounts of monomers used can vary widely, because of the wide variation in the monomer loss during polymerization, depending on the efficiency of distillation columns and other kinds of recovery and recycle systems and the like, and are only an approximation. Exact amounts of monomers that are charged to a specific reactor to achieve a specific composition can be determined by a skilled practitioner.

In the melt polymerization process, the monomers are combined, and are heated gradually with mixing with a catalyst or catalyst mixture to a temperature in the range of 220° C. to about 300° C., preferably 240° C. to 295° C. The exact conditions and the catalysts depend on whether the diacids are polymerized as true acids or as dimethyl esters. The catalyst can be included initially with the reactants, and/or can be added one or more times to the mixture as it is heated. The catalyst used can be modified as the reaction proceeds. The heating and stirring are continued for a sufficient time and to a sufficient temperature, generally with removal by distillation of excess reactants, to yield a molten polymer having a high enough molecular weight to be suitable for the intended application.

Continuous polymerization process for manufacturing poly(ethylene terephthalate) using dimethyl terephthalate (“DMT”) and ethylene glycol are well documented in open literature. In general, a typical process begins with the transesterification of DMT with ethylene glycol at a mole ratio from 1.05 to about 2.50 with a preference near 1.75 to about 1.90. The mixture is heated typically from 180-230° C. in the presence of a transesterification catalyst such as manganese, zinc, or titanium. The second stage of the process involves polycondensation of the polymer under increasing heat and increasing vacuum. This second step may involve more than one vessel with agitation by any of various methods listed in common literature. Typical process temperatures will be from 280° C.-310° C., with 290° C. preferable, but dependent on the polymer being produced. The vacuum is incrementally increased in the subsequent vessels to reach between 1 and 10 torr, with a typical operating vacuum between 2 and 5 torr.

Catalysts that can be used include salts of Li, Ca, Mg, Mn, Zn, Pb, Sb, Sn, Ge, and Ti, such as acetate salts and oxides, including glycol adducts, and Ti alkoxides. Suitable catalysts are generally known, and the specific catalyst or combination or sequence of catalysts used can be selected by a skilled practitioner. The preferred catalyst and preferred conditions differ depending on, for example, whether the diacid monomer is polymerized as the free diacid or as a dimethyl ester, and the exact chemical identity of the diol component.

Polyesters can also be produced directly from polymerizable polyester monomers. Some representative examples of suitable polymerizable polyester monomers for use in the present invention include hydroxyacids such as hydroxybenzoic acids, hydroxynaphthoic acids and lactic acid; bis(2-hydroxyethyl) terephthalate, bis(4-hydroxybutyl) terephthalate, bis(2-hydroxyethyl)naphthalenedioate, bis(2-hydroxyethyl)isophthalate, bis[2-(2-hydroxyethoxy)ethyl]terephthalate, bis[2-(2-hydroxyethoxy)ethyl]isophthalate, bis[(4-hydroxymethylcyclohexyl)methyl]terephthalate, and bis[(4-hydroxymethylcyclohexyl)methyl]isophthalate, mono(2-hydroxyethyl)terephthalate, bis(2-hydroxyethyl)sulfoisophthalate, and lactide.

Polyesters can also be produced directly from macrocyclic polyester oligomers. Macrocyclic polyester oligomers that may be employed in this invention include, but are not limited to, macrocyclic poly(alkylene dicarboxylate) oligomers having a structural repeat unit of the formula: 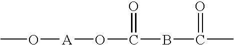
wherein A is an alkylene group containing at least two carbon atoms, a cycloalkylene, or a mono- or polyoxyalkylene group; and B is a divalent aromatic or alicyclic group. They may be prepared in a variety of ways, such as those described in U.S. Pat. Nos. 5,039,783, 5,231,161, 5,407,984, 5,668,186, United States Patent Publication No. 2006/128935, PCT Patent Applications WO 2003093491 and WO 2002068496, and A. Lavalette, et al., Biomacromolecules, vol. 3, p. 225-228 (2002). Macrocyclic polyester oligomers can also be obtained through extraction from low-molecular weight linear polyester.

Preferred macrocyclic polyester oligomers are macrocyclic polyester oligomers of 1,4-butylene terephthalate (CBT); 1,3-propylene terephthalate (CPT); 1,4-cyclohexylenedimethylene terephthalate (CCT); ethylene terephthalate (CET); 1,2-ethylene 2,6-naphthalenedicarboxylate (CEN); the cyclic ester dimer of terephthalic acid and diethylene glycol (CPEOT); and macrocyclic co-oligoesters comprising two or more of the above structural repeat units.

Fibers may be extruded and spun from most any achievable molecular weight polyester. Polymers having adequate inherent viscosity for many applications can be made by the melt condensation process above; however, a melt process does not produce polymer with high enough molecular weight for some fiber applications where high tensile properties and improved fatigue behavior are necessary. Applications include industrial yarns, such as monofilament fibers for industrial paper making machines and high-strength rope (as in lobster trap lines) or reinforcing fabrics. Tire cord is another instance where high molecular weight and related tensile properties is desired. In such cases, the molecular weight of the polymer may be increased through solid-state polycondensation of the polymer, a process referred to as “solid stating.” The need for solid stating would be determined by the desired end use. The polymer is heated under vacuum, nitrogen purge, or vacuum with a slight nitrogen bleed or purge. The temperature is typically from 180° C. to just below the melting point of the polymer; a temperature between 220° C. and 230° C. as preferred. The polymer is held under these conditions, typically with agitation, for a determined period of time. At the end of the prescribed time, the polymer is cooled. This polymer is then referred to as being solid-stated and considered appropriate for forming into fibers for high molecular weight applications.

Polymers made by melt polymerization, after extruding, cooling and pelletizing, can be essentially noncrystalline. Noncrystalline material can be made semicrystalline by heating it to a temperature above the glass transition temperature for an extended period of time. This induces crystallization so that the product can then be heated to a higher temperature to raise the molecular weight. Semicrystallinity in the polymer may be preferred for some end uses.

If a higher molecular weight semicrystalline polymer is desired, crystallinity can be induced prior to solid stating by treatment with a relatively poor solvent for polyesters that induces crystallization. Such solvents reduce the glass transition temperature (Tg) allowing for crystallization. Solvent induced crystallization is known for polyesters and is described in U.S. Pat. Nos. 5,164,478 and 3,684,766. The semicrystalline polymer is then subjected to solid-state polymerization by placing the pelletized or pulverized polymer into a stream of an inert gas, usually nitrogen, or under a vacuum of 1 Torr, at an elevated temperature, but below the melting temperature of the polymer for an extended period of time

### Process Conditions

Process conditions for making the nanocomposite material are the same as those known in the art for manufacturing polyesters in a melt or solution process. The sepiolite clay mineral can be added by any means known in the art at any convenient stage of manufacture before the polyester degree of polymerization is about 20. For example, it can be added at the beginning with the monomers, during monomer esterification or ester-interchange, at the end of monomer esterification or ester-interchange, or early in the polycondensation step.

If the production of diethylene glycol (“DEG”) needs to be controlled during the reaction, a range of catalysts can be used. These include the use of lithium acetate buffers as described in U.S. Pat. No. 3,749,697 and a range of sodium and potassium acetate buffers as described in JP 83-62626, RO 88-135207, and JP 2001-105902. Typically, 100-600 ppm of sodium or potassium acetate is used during the polymerization to minimize the degree of DEG formation and incorporation into the polymer.

### Optional Additional Ingredients

The polyester nanocomposites can contain additives, fillers, and/or other materials. Useful additives include hydrolysis stabilization additives, thermal stabilizers, antioxidants, UV absorbers, UV stabilizers, processing aids, waxes, lubricants, color stabilizers, and the like. Fillers include calcium carbonate, glass, kaolin, talc, clay, carbon black, and the like. Other materials that can be incorporated include nucleants, pigments, dyes, delusterants such as titanium dioxide and zinc sulfide, antiblocks such as silica, antistats, flame retardants, brighteners, silicon nitride, metal ion sequestrants, anti-staining agents, silicone oil, surfactants, soil repellants, modifiers, viscosity modifiers, zirconium acid, reinforcing fibers, and the like. The additives, fillers, and other materials can be incorporated within the polyester nanocomposites by a separate melt compounding process utilizing any known intensive mixing process, such as extrusion; by intimate mixing with solid granular polymer, such as pellet blending, or by co-feeding within the monofilament process.

The polyester nanocomposites can be blended with other polymers. Such other polymers include polyolefins, such as polyethylene, polypropylene, polybutene, poly4-methyl pentene, polystyrene, and the like; cyclic olefin polymers, modified polyolefins, such as copolymers of various alpha-olefins, glycidyl esters of unsaturated acids, ionomers, ethylene/vinyl copolymers such as ethylene/vinyl chloride copolymers, ethylene/vinyl acetate copolymers, ethylene/acrylic acid copolymers, ethylene/methacrylic acid copolymers and the like, thermoplastic polyurethanes, polyvinyl chloride, polyvinylidene chloride copolymers, liquid crystalline polymers, fluorinated polymers such as polytetrafluoroethylene, ethylene tetrafluoroethylene copolymers, tetrafluoroethylene hexafluoropropylene copolymers, polyfluoroalkoxy copolymers, polyvinylidene fluoride, polyvinylidene copolymers, ethylene chlorotrifluoroethylene copolymers, and the like, polyamides, such as nylon 6, nylon 66, nylon 69, nylon 610, nylon 611, nylon 612, nylon 11, nylon 12, and copolymers and the like, polyimides, polyphenylene sulfide, polyphenylene oxide, polysulfones, polyethersulfones, rubbers, polycarbonate, polyacrylates, terpene resins, polyacetal, styrene/acrylonitrile copolymers, styrene/maleic anhydride copolymers, styrene/maleimide copolymers, coumarone/indene copolymers, and the like and combinations thereof. Polyester monofilaments that incorporate thermoplastic polyurethanes are disclosed in U.S. Pat. Nos. 5,169,711 and 5,652,057. Polyester monofilaments that incorporate polyphenylene sulfide are disclosed in U.S. Pat. Nos. 5,218,043, 5,424,125, and 5,456,973. Polyester monofilaments that incorporate fluoropolymers are disclosed in U.S. Pat. Nos. 5,283,110, 5,297,590, 5,378,537, 5,407,736, 5,460,869, 5,472,780, 5,489,467, and 5,514,472. Polyester monofilaments that incorporate non-fluorine-containing polymers are disclosed in U.S. Pat. No. 5,686,552. Polyester monofilaments that incorporate liquid crystalline polymers are disclosed in U.S. Pat. No. 5,692,938. The other polymers can be added to the polyester nanocomposites by a separate melt compounding process utilizing any known intensive mixing process, such as extrusion through a single or twin screw extruder, through intimate mixing with the solid granular material, such as mixing, stirring or pellet blending operations, or through co-feeding within the monofilament process.

The polyester nanocomposites can be stabilized with an effective amount of any hydrolysis stabilization additive. The hydrolysis stabilization additive can be any known material that enhances the stability of the polyester nanocomposite monofilament to hydrolytic degradation. Examples of the hydrolysis stabilization additive can include: diazomethane, carbodiimides, epoxides, cyclic carbonates, oxazolines, aziridines, keteneimines, isocyanates, alkoxy end-capped polyalkylene glycols, and the like. Any material that increases the hydrolytic stability of the monofilaments formed from the polyester nanocomposites is suitable.

Preferred hydrolysis stabilization additives are carbodiimides. Specific examples of carbodiimides include N,N′-di-o-tolylcarbodiimide, N,N′-diphenylcarbodiimide, N,N′dioctyldecylcarbodiimide, N,N′-di-2,6-dimethylphenylcarbodiimide, N-tolyl-N′cyclohexylcarbodiimide, N,N′-di-2,6-diisopropylphenylcarbodiimide, N,N′di-2,6-di-tert.-butylphenylcarbodiimide, N-tolyl-N′-phenylcarbodiimide, N,N′-di-p-nitrophenylcarbodiimide, N,N′di-p-aminophenylcarbodiimide, N,N′-di-p-hydroxyphenylcarbodiimide, N,N′-di-cyclohexylcarbodiimide, N,N′-di-p-tolylcarbodiimide, p-phenylene-bis-di-o-tolylcarbodiimide, p-phenylene-bisdicyclohexylcarbodiimide, hexamethylene-bisd icyclohexylcarbod iimide, ethylene-bisdiphenylcarbodiimide, benzene-2,4-diisocyanato-1,3,5-tris(1-methylethyl) homopolymer, a copolymer of 2,4-diisocyanato-1,3,5-tris(10methylethyl) with 2,6-diisoproyl diisocyanate, and the like. Such materials are commercially sold under the trade names: STABAXOL® 1, STABAXOL® P, STABAXOL® P-100, STABAXOL® KE7646, (Rhein-Chemie, of Rheinau GmbH, Germany and Bayer). The use of carbodiimides as polyester hydrolysis stabilization additives is disclosed in U.S. Pat. Nos. 3,193,522, 3,193,523, 3,975,329, 5,169,499, 5,169,711, 5,246,992, 5,378,537, 5,464,890, 5,686,552, 5,763,538, 5,885,709 and 5,886,088.

Specific examples of epoxides suitable as hydrolysis stabilization additives include iso-nonyl-glycidyl ether, stearyl glycidyl ether, tricyclo-decylmethylene glycidyl ether, phenyl glycidyl ether, p-tert.-butylphenyl glycidyl ether, o-decylphenyl glycidyl ether, allyl glycidyl ether, butyl glycidyl ether, lauryl glycidyl ether, benzyl glycidyl ether, cyclohexyl glycidyl ether, alpha-cresyl glycidyl ether, decyl glycidyl ether, dodecyl glycidyl ether, N-(epoxyethyl)succinimide, N-(2,3-epoxypropyl)phthalimide, and the like. Catalysts can be included to increase the rate of reaction, for example; alkali metal salts. Epoxides are disclosed as polyester hydrolysis stabilization additives in U.S. Pat. Nos. 3,627,867, 3,657,191, 3,869,427, 4,016,142, 4,071,504, 4,139,521, 4,144,285, 4,374,960, 4,520,174, 4,520,175, 5,763,538, and 5,886,088.

Specific examples of cyclic carbonates suitable as hydrolysis stabilization additives include ethylene carbonate, methyl ethylene carbonate, 1,1,2,2-tetramethyl ethylene carbonate, 1,2-diphenyl ethylene carbonate, and the like. Cyclic carbonates, such as ethylene carbonate, are disclosed as hydrolysis stabilization additives in U.S. Pat. Nos. 3,657,191, 4,374,960, and 4,374,961.

The amount of hydrolysis stabilization additive required to lower the carboxyl concentration of the polyester nanocomposite during its conversion to monofilaments is dependent on the carboxyl content of the polyester nanocomposite prior to extrusion into monofilaments. In general, the amount of hydrolysis stabilization additive used is from 0.1 to 10.0 weight percent based on the polyester nanocomposite. Preferably the amount of the hydrolysis stabilization additive used is in the range of 0.2 to 4.0 weight percent.

The hydrolysis stabilization additive can be incorporated within the branched polyester nanocomposites by a separate melt compounding process as disclosed hereinabove for incorporation of other polymers into the polyester nanocomposites. However, it is preferred that the hydrolysis additive is incorporated through co-feeding within the monofilament process.

### Production of Monofilament Fiber and Multifilament Yarn

Monofilament fiber comprising a polyester nanocomposite into which is incorporated an effective amount of exfoliated sepiolite-type clay are produced by extrusion (for example, using a single screw or twin screw extruder) of the polyester nanocomposite itself or, if the polyester nanocomposite is being used as a masterbatch, a mixture of the polyester nanocomposite with enough additional polyester that the extruded fiber will contain the desired effective amount of exfoliated sepiolite-type clay. Typical processes for producing fibers are well documented in the open literature. Any known process for producing monofilaments can be used to form monofilaments from the polyester nanocomposites.

Typically, the extruded polymer is heat treated and drawn to produce filaments. The fiber may be subjected to a draw ratio of approximately 2:1 to 6.5:1. Fibers containing increasing amounts of the exfoliated sepiolite-type clay show a corresponding notable increase in tensile modulus as compared to polyester fibers produced under the same conditions not containing the sepiolite-type clay.

Specifically, the polyester nanocomposites can be formed into monofilaments by known methods such as, for example, methods disclosed in U.S. Pat. Nos. 3,051,212, 3,999,910, 4,024,698, 4,030,651, 4,072,457, and 4,072,663. As one skilled in the art will appreciate, the process can be tailored to take into account the exact material to be formed into monofilaments, the physical and chemical properties desired in the monofilament, and the like. The spinning conditions needed to achieve a certain combination of monofilament properties can be determined routinely by measuring the dependence of the contemplated monofilament property on the composition of the polyester nanocomposite and on the spinning conditions.

An integrated continuous polymerization/filament extrusion process may be used to manufacture the polyester nanocomposite and immediately extrude the melt into filaments. Where the two processes are separate, the polyester nanocomposites are preferably dried prior to their formation into monofilaments. To form monofilaments, the polyester nanocomposites are melted at a temperature in the range of about 150° C. to about 300° C. Preferably, the polyester nanocomposites are melted at a temperature within the range of about 170° C. to about 290° C. The spinning can generally be carried out by use of a spinning grid or an extruder. The extruder melts the dried granular polyester nanocomposite and conveys the melt to the spinning aggregate by a screw. This screw is designed to suit the application at hand and may contain additional mixing sections and flights to produce the desired product. It is well known that polyesters will tend to degrade thermally based on time and temperature in the melt. Therefore, it is preferred that the time that the polyester nanocomposite is in the melt is minimized by the use of the shortest practical length of pipes between the melting of the polyester nanocomposite and the spinneret. The molten polyester nanocomposite can be filtered through, for example, screen filters, to remove any undesired particulate foreign matter.

The molten polyester nanocomposite can then be conveyed, optionally through a metering pump, through a die to form a monofilament. After exiting the die, the monofilaments can be quenched in an air or a water bath to form solid monofilaments. The monofilament can optionally be spin finished. The monofilaments can be drawn at elevated temperatures up to 100° C. between a set of draw rolls. If the temperature is too high, sticking may occur and/or control over the drawing of the monofilaments may be lost. The monofilament is preferably drawn at a draw ratio of about 3.0:1 to about 6.0:1 when heated to a temperature up to about 100° C.-200° C. in drawing ovens. More preferably, the monofilaments are drawn to a draw ratio of from 3.0:1 to 4.5:1, and optionally be further drawn at a higher temperature of up to 250° C. to a maximum draw ratio of 6.5:1 and allowed to relax up to about 30 percent maximum while heated in a relaxing stage. Draw ratio is defined as the ratio of the drawn monofilament length to the undrawn monofilament length. Relaxation of the fiber is dependent upon the application at hand and the desires of those skilled in the practice to affect the desired properties in the fiber. The polyester nanocomposite monofilament is allowed to cool and can then be wound up onto spools or reels.

In order to provide the desired tenacity, the filaments can be drawn to a ratio of at least about 2:1. Preferably, the filaments are drawn to a ratio of at least about 4:1 and up to about 6:1. The overall draw ratio can be varied to allow for monofilament production of various denier. Typically, a nominal denier of 24 to 86,000 is desired.

Monofilaments can range in size over a broad range depending on intended use, preferably from a diameter of about 0.05 millimeters (mm) to about 5.0 mm and more preferably having a diameter of from about 0.05 mm to about 3 mm. Also, Typical ranges of sizes of monofilaments used in press fabrics and dryer fabrics are 0.20 mm to 1.27 mm in diameter. Depending upon the cross-sectional shape of the monofilaments, monofilaments having masses within the mass of a typical monofilament having a diameter within the stated range can be produced, and may have diameters outside the above-stated range. For forming fabrics, finer monofilaments are generally used, for example, as small as 0.05 mm to about 0.9 mm in diameter. Most often, the monofilaments used in forming fabrics have a diameter between about 0.12 mm to about 0.4 mm. On the other hand, for special industrial applications, such as belts on machines used in manufacture of paper, commonly referred to as “paper machine clothing” where monofilaments of 3.8 mm in diameter or greater can be desired.

The monofilaments can take any cross-sectional shape, for example; as circle, flattened figure, square, triangle, pentagon, polygon, multifoil, dumbbell, cocoon. The term “flattened figure” as used herein refers to an ellipse or a rectangle. The term not only embraces a geometrically defined exact ellipse and rectangle but also shapes similar to an ellipse or a rectangle, e.g., an imperfect ellipse or an irregular polygon, and includes a shape obtained by rounding the four corners of a rectangle. When a monofilament is intended as a warp in a papermaking drier canvas, a monofilament having the cross-sectional shape of a flattened figure is preferably used to improve the resistance against staining and ensure a flatness of the produced drier canvas. The monofilaments can further be woven into textile fabrics, using known processes.

Multifilament yarns can be produced comprising the polyester nanocomposites described herein using any of the typical processes well known in the art for making multifilament polyester yarns (see, e.g., Reese, Glen, “Polyesters, Fibers” in Encyclopedia of Polymer Science and Technology, John Wiley & Sons, Inc. (2002), vol. 3, 652-678; U.S. Pat. Nos. 3,409,496, 4,933,427, 4,929,698, 5,061,422, 5,277,858; British Patent 1,162,506). Textile filament yarns are continuous yarns produced at high speeds and are used for fabrics with silk-like esthetics. Industrial filament yarns are used for rubber reinforcement and high strength industrial fabrics. Typical scales of-spinning are about 750 filaments per spinneret at a pack throughput of about 100 kg/h for industrial filament and about 100 filaments per spinneret at a pack throughput of about 12 kg/h for textile filament.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations is as follows: “min” means minute(s), “kg” means kilogram(s), “g” means gram(s), “g/d” means grams per denier “lb” means pound(s), “wt %” means weight percent(age), “DMT” means dimethyl terephthalate, “DEG” mean diethylene glycol, “SEC” means size exclusion chromatography, “Mₙ” means number average molecular weight, “RPM” means revolutions per minute, “psi” means pound per square inch and “MPa” means megapascal.

### Materials

Dimethyl terephthalate (99%) (CAS # 120-61-6) was purchased from Invista (Wilmington, N.C.). Ethylene glycol (99%) (CAS # 107-21-1) was purchased from PD Glycol (Beaumont, Tex.). Germanium dioxide (CAS # 1310-53-8) was purchased from Umicore Electro-optic Materials (Belgium). Antimony trioxide (CAS # 1309-64-4, 99%) was purchased from Laurel Industries (La Porte, Tex.) Manganese acetate (CAS # 6156-78-1, 99%) was purchased from Shepard Chemicals (Cincinnati, Ohio). Potassium acetate was purchased from Wako Chemicals (Richmond, Va.) The above ingredients in equivalent purity and properties from other sources are typically acceptable. Pangel® S-9 sepiolite was purchased from EM Sullivan Associates, Inc. (Paoli, Pa.). The control PET sample used was Crystar® 5148, obtained from E. I. du Pont de Nemours & Co., Inc. (Wilmington, Del.).

### Analvtical Methods

A size exclusion chromatography system comprised of a Model Alliance 2690TM from Waters Corporation (Milford, Mass.), with a Waters 410TM refractive index detector (DRI) and Viscotek Corporation (Houston, Tex.) Model T-60ATM dual detector module incorporating static right angle light scattering and differential capillary viscometer detectors was used for molecular weight characterization. The mobile phase was 1,1,1,3,3,3-hexafluoro-2-propanol (HFIP) with 0.01 molar sodium trifluoroacetate The dn/dc was measured for the polymers and it was assumed that all of the sample was completely eluted during the measurement. The percentage of diethylene glycol (DEG) was determined by depolymerization and subsequent GC (gas chromatographic) analysis.

IV of the polymers was measured according to ASTM D5225-92. The solvent system was a 1:1 mixture of trifluoroacetic acid:methylene chloride.

The tensile properties of the nanocomposite fibers were determined according to ASTM procedure D882 with appropriate environmental preconditioning of the samples. The instrumentation was a 5500 Retrofit 1122 Instron® test system, with Instron® Merlin™ software. The instrument was fitted with a 50# cell and type 4C yarn and Cord Grips (Instron Corporation, Canton, Mass.).

### Example 1

### Polyester-Sepiolite Nanocomposite Preparation

The autoclave process of creating the polyester-sepiolite nanocomposite formulation involves reaction of DMT (10.1 lb, 4.59 kg), ethylene glycol (6.7 lb, 3.0 kg), antimony trioxide (2.80 g), manganese acetate (3.60 g), potassium acetate (1.30 g), and Pangel® S-9 sepiolite (140.0 g). The reaction vessel was purged with 60 psi (0.41 MPa) of nitrogen three times. The vessel was heated to 240° C. with a low flow nitrogen sweep of the vessel. While the vessel was heating to 240° C. the reaction was agitated at 25 RPM. After the vessel reached 240° C., the reaction temperature was maintained for 10 min. The reaction was then heated to 275° C. and a 90 minute vacuum reduction cycle was begun. Upon completion of the vacuum reduction cycle, a full vacuum (0.1 torr) was applied to the reaction and the reaction was maintained at 275° C. for 120 min. The reaction was pressurized with nitrogen and the polymer was extruded as a strand, cooled in a water trough, and chopped into pellet form. The polymer molecular weight Mₙ was determined to be about 24600, using SEC. The amount of DEG was determined to be 2.89 wt %.

Polymers were also synthesized using germanium dioxide (120 ppm) as the polymerization catalyst in place of antimony trioxide. Either of these formulations is referred to as the PET nanocomposite, or nanocomposite polyester, in the following examples.

### Example 2

Polyester nanocomposites containing to 0 to 3.1 wt % different concentrations of sepiolite were produced by addition into a typical continuous polymerization process for manufacturing poly(ethylene terephthalate) using dimethyl terephthalate (“DMT”) and ethylene glycol as described above. The polyester nanocomposites were dried at 150° C. for 4-6 hours and then were melted at a temperature in the range of about 290-300° C. in an single screw extruder. The molten polyester nanocomposite was then conveyed, through a metering pump, through a filter screen of near 60 micrometers opening, and through a die to form the monofilament. After exiting the die, the monofilaments were quenched in a water bath. The polyester nanocomposite monofilaments were drawn at elevated temperatures, from 100° C. and 175° C., with a preference of about 150° C., between a series of two sets of draw rolls to a draw ratio of 4.55:1. The fibers were allowed to relax up to about 30 percent maximum while heated in a relaxing stage at a third set of draw rolls. The polyester nanocomposite monofilament was allowed to cool and was then wound up on a spool. Tenacity and modulus data are presented in Table 1.

TABLE 1

| Sepiolite, | | | Tenacity, | Modulus, |
|---|---|---|---|---|
| (wt % in PET) | Draw Ratio | Denier | (g/d) | (g/d) |
| 0* | 4.46 | 2830 | 3.8 | 95 |
| 1.14 | 4.46 | 2840 | 3.4 | 100 |
| 2.18 | 4.46 | 2850 | 3.7 | 105 |
| 2.79 | 4.46 | 2805 | 3.7 | 112 |

*Crystar ® 5148 PET control

What is claimed is:

1. A monofilament comprising a polyester nanocomposite into which is incorporated an effective amount of unmodified sepiolite-type clay particles.

2. The monofilament of claim 1 wherein the wherein the width and thickness of the sepiolite-type clay particles are each less than 50 nm.

3. The monofilament of claim 1 wherein the sepiolite-type clay is rheological grade.

4. The monofilament of claim 1 wherein the monofilament is drawn at a draw ratio of about 3.0:1 to about 6.0:1 when heated to a temperature between about 100° C. and about 200° C. in a drawing oven.

5. The monofilament of claim 1, having a diameter of from about 0.05 mm to about 3 mm, or a nominal denier of 24 to 86,000.

6. The monofilament of claim 1 wherein the sepiolite-type clay is present in an amount from about 0.1 wt %. to about 10 wt % based on the weight of the monofilament.

7. The monofilament of claim 1 wherein the polyester is selected from the group consisting of: at least one polyester homopolymer; at least one polyester copolymer; a polymeric blend comprising at least one polyester homopolymer or copolymer; and mixtures of these.

8. The monofilament of claim 1 wherein the polyester is poly(ethylene terephthalate), poly(1,3-propylene terephthalate), poly(1,4-butylene terephthalate), a thermoplastic elastomeric polyester having poly(1,4-butylene terephthalate) and poly(tetramethylene ether)glycol blocks, poly(1,4-cylohexyldimethylene terephthalate), or polylactic acid.

9. A multifilament polyester yarn or textile fabric comprising the monofilament of claim 1.

10. A finished article comprising the monofilament of claim 1.

11. The finished article of claim 10 wherein said article is selected from the group consisting of rubber articles, fishing lines, toothbrush bristles, paintbrush bristles, industrial belts, paper machine clothing, tire cords, composites, and textiles.

12. A method for increasing the modulus of polyester monofilament, comprising the steps:
a. preparing a polyester nanocomposite by mixing a sepiolite-type clay with at least one polyester precursor selected from the group consisting of
(i) at least one diacid or diester and at least one diol;
(ii) at least one polymerizable polyester monomer;
(iii) at least one linear polyester oligomer; and
(iv) at least one macrocyclic polyester oligomer;
b. subsequently polymerizing the at least one polyester precursor in the presence or absence of solvent; and
c. melt spinning monofilament comprising the polyester nanocomposite so produced.

13. The method of claim 12 wherein the at least one diacid or diester is selected from the group consisting of terephthalic acid, isophthalic acid, naphthalene dicarboxylic acids, cyclohexane dicarboxylic acids, succinic acid, glutaric acid, adipic acid, sebacic acid, 1,12-dodecane dioic acid, fumaric acid, maleic acid, and the dialkyl esters thereof.

14. The method of claim 12 wherein the at least one diol is selected from the group consisting of ethylene glycol, 1,3-propylene glycol, 1,2-propylene glycol, 2,2-diethyl-1,3-propane diol, 2,2-dimethyl-1,3-propane diol, 2-ethyl-2-butyl-1,3-propane diol, 2-ethyl-2-isobutyl-1,3-propane diol, 2-ethyl-2-butyl-1,3-propane diol, 2-ethyl-2-isobutyl-1,3-propane diol, 1,3-butane diol, 1,4-butane diol, 1,5-pentane diol, 1,6-hexane diol, 2,2,4-trimethyl-1,6-hexane diol, 1,2-cyclohexane dimethanol, 1,3-cyclohexane dimethanol, 1,4-cyclohexane dimethanol, 2,2,4,4-tetramethyl-1,3-cyclobutane diol, isosorbide, naphthalene glycols, diethylene glycol, triethylene glycol, resorcinol, hydroquinone, and longer chain diols and polyols which are the reaction products of diols or polyols with alkylene oxides.

15. The method of claim 12 wherein the at least one polymerizable monomer is selected from the group consisting of hydroxyacids, lactide, bis(2-hydroxyethyl) terephthalate, bis(4-hydroxybutyl) terephthalate, bis(2-hydroxyethyl)naphthalenedioate, bis(2-hydroxyethyl)isophthalate, bis[2-(2-hydroxyethoxy)ethyl]terephthalate, bis[2-(2-hydroxyethoxy)ethyl]isophthalate, bis[(4-hydroxymethylcyclohexyl)methyl]terephthalate, and bis[(4-hydroxymethylcyclohexyl)methyl]isophthalate, mono(2-hydroxyethyl)terephthalate, and bis(2-hydroxyethyl)sulfoisophthalate.

16. The method of claim 12 wherein the at least one macrocyclic polyester oligomer is a macrocyclic polyester oligomer of: 1,4-butylene terephthalate, 1,3-propylene terephthalate, 1,4-cyclohexylenedimethylene terephthalate, ethylene terephthalate, 1,2-ethylene 2,6-naphthalenedicarboxylate; the cyclic ester dimer of terephthalic acid and diethylene glycol; or a macrocyclic co-oligoester of two or more of these.

17. The method of claim 12 wherein the at least one diacid or diester is one or more of terephthalic acid, isophthalic acid, dimethyl terephthalate, and 2,6-naphthalene dicarboxylic acid; and the at least one diol is one or more of HO(CH₂)ₙOH, 1,4-cyclohexanedimethanol, HO(CH₂CH₂O)ₘCH2CH2OH, and HO(CH₂CH₂CH₂CH₂O)_{z}CH₂CH₂CH₂CH₂OH, wherein n is an integer of 2 to 10, m on average is 1 to 4, and z on average is about 7 to about 40.

18. The method of claim 12 wherein the polyester is poly(ethylene terephthalate), poly(1,3-propylene terephthalate), poly(1,4-butylene terephthalate), a thermoplastic elastomeric polyester having poly(1,4-butylene terephthalate) and poly(tetramethylene ether)glycol blocks, poly(1,4-cylohexyldimethylene terephthalate), or polylactic acid.
